(19) United States
(12) Patent Application Publication
(10) Pub. No.: US 2013/0036178 A1
(43) Pub. Date: Feb. 7, 2013

(54) DISSEMINATING INFORMATION

(71) Applicant: Jason Pitt, Bloxwich (GB)

(72) Inventor: Jason Pitt, Bloxwich (GB)

(21) Appl. No.: 13/204,480

(22) Filed: Aug. 5, 2011

(51) Int. Cl. G06F 15/16

(52) U.S. Cl. 709/206

(57) ABSTRACT

A method of, and server for, disseminating information, the method comprising uploading information to a server, selecting a first set of recipients and a second set of recipients, applying at the server a first template to the information to create a first electronic message, applying at the server a second template to the information to create a second electronic message, and the server sending the first electronic message to the first set of recipients and the second electronic message to the second set of recipients. Thus, electronic messages containing the information in different formats can be sent to the different set of recipients with the user only having two upload the information once. The first set can comprise media contacts (such as journalists and public relations professionals), whereas the second set can comprise potential recipients, such as customers of the user, uploaded to the server by the user.

### BACKGROUND OF THE DISCLOSURE

1. Field of the Disclosure

This disclosure relates to a method of disseminating information.

2. Description of the Related Art

Writing press releases for release to media professionals such as journalist is a well known chore for businessmen or their in-house marketing teams. Similarly, to date, if the businessman has a newsworthy story which they want to share with the media as well as their clients, they have had to write two separate documents: a press release for the media professionals and a mailshot or similar for their customers. This represents a duplication of effort. Similarly, updating the company website is a third chore, and publicizing the update on the web a fourth.

Typically, many small and medium size enterprises, run by time-starved businessmen, have had to choose between the stark choices of failure to capitalise on potentially newsworthy stories and employing a potentially expensive public relations professional to do these tasks for them.

### BRIEF SUMMARY OF THE DISCLOSURE

According to a first aspect of the disclosure, there is provided a method of disseminating information, comprising uploading information to a server, selecting a first set of recipients and a second set of recipients, applying at the server a first template to the information to create a first electronic message, applying at the server a second template to the information to create a second electronic message, and the server sending the first electronic message to the first set of recipients and the second electronic message to the second set of recipients.

Thus, the appearance of the information can be tailored for the different sets of recipients, with a user having to upload the information to the server only once.

Preferably, first set of recipients is selected from a first superset of potential recipients; the second set of recipients is selected from a second superset of potential recipients; and the first superset and the second superset of recipients are not equal (and typically are disjoint).

The first superset and the second superset may each comprise potential recipients, taken from different sources. The first superset may comprise or consist potential recipients provided other than by a user uploading the information. The second superset may comprise or consist potential recipients provided by the user uploading the information. For example, the first superset may comprise a list of media contacts (such as journalists and public relations professionals) provided by the server operator as potential recipients, whereas the second superset may comprise potential recipients, such as customers of the user, uploaded to the server by the user.

By applying the differing templates to the information to create differently-formatted messages for recipients from the different supersets, the templates can deal with the different expectations of the recipients in the different supersets. Thus, the media contacts, who expect their information to be in the form of a press release, will receive an appropriately-formatted press release, whilst customers or other contacts will receive a mailshot or something they typically find more user-friendly.

The method may further comprise the step of sending at least some, if not all, of the information to a webserver, so that the information sent appears on a web page. The web page may be a social networking website, such as Facebook®, MySpace® or QZone®. Additionally or alternatively, the web page may be a news page for the user. In such a case, the web server may contain a news page for each of a plurality of users of the server. The server may be arranged to apply a news page template to the information sent to the web server; a different news page template may be provided for each user of the server.

In addition, a subset of the information may be sent to a further webserver, so as to appear on a further web page. The information sent to the further website may comprise a link to the web page of the webserver, so that the further web page links (typically using a hypertext markup language (HTML) link) to the web page. The subset of the information may comprise less than 200 characters, typically a maximum of 140. Typically, the further webserver will be that of a microblogging service (such as the well known Twitter® service). Thus, a short message, typically only comprising a headline and a link, can be provided to publicise the article stored on the web server.

According to a second aspect of the disclosure, there is provided a server for disseminating information, the server comprising:
an input configured to receive information;
storage configured to store a first superset of recipients and a second superset of recipients;
a user interface configured to allow a user to select a first set of recipients from the first superset of recipients and to select a second set of recipients from a second superset of recipients;
processing circuitry configured to apply a first template to the information to create a first electronic message, and to apply a second template to the information to create a second electronic message;
and an output configured to send first electronic message to the first set of recipients and the second electronic message to the second set of recipients.

Thus, the appearance of the information can be tailored for the different sets of recipients, with a user having to upload the information to the server only once.

Preferably, the first superset and the second superset of recipients are not equal (and typically are disjoint).

The first superset and the second superset may each comprise potential recipients, taken from different sources. The first superset may comprise or consist or potential recipients provided other than by a user uploading the information. The second superset may comprise or consist of potential recipients provided by the user uploading the information. For example, the first superset may comprise a list of media contacts (such as journalists and public relations professionals) provided by the server operator as potential recipients, whereas the second superset may comprise potential recipients, such as customers of the user, uploaded to the server by the user.

The output may be configured to send at least some, if not all, of the information to a webserver, so that the information sent appears on a web page. Alternatively, the server may be configured to act as a webserver, so that the information sent appears on a web page served by the server; in such a case, the storage may be arranged to store the web page, and the output may be arranged to output the web page on request.

The web page may be a social networking website, such as Facebook®, MySpace® or QZone®. Additionally or alternatively, the web page may be a news page for the user. In such a case, the web server may contain a news page for each of a plurality of users of the server. The server may be configured to apply a news page template to the information sent to the web server; a different news page template may be provided for each user of the server.

In addition, the output may be configured to send a subset of the information to a further webserver, so as to appear on a further web page. The information sent to the further website may comprise a link to the web page of the webserver, so that the further web page links (typically using a hypertext markup language (HTML) link) to the web page. The subset of the information may comprise less than 200 characters, typically a maximum of 140. Typically, the further webserver will be that of a microblogging service (such as the well known Twitter® service). Thus, a short message, typically only comprising a headline and a link, can be provided to publicise the article stored on the web server.

There now follows, by way of example only, embodiments of the disclosure described with reference to and as illustrated in the accompanying drawings, in which:

### BRIEF DESCRIPTION OF THE SEVERAL VIEWS OF THE DRAWINGS

FIG. 1 shows a schematic view of several network nodes, cooperating to implement an embodiment of the disclosure;

FIG. 2 shows schematically the server of FIG. 1;

FIG. 3 shows a web page whereby information is being uploaded onto the server of FIG. 1;

FIG. 4 shows the media contacts database of the server of FIG. 1;

FIG. 5 shows the user contacts database of the server of FIG. 1;

FIG. 6 shows a press release as sent out to selected media contacts by the server of FIG. 1;

FIG. 7 shows an electronic mailshot as sent out to selected customer contacts by the server of FIG. 1;

FIG. 8a shows a news web page with the information uploaded to it by the server of FIG. 1

FIG. 8b shows a news index web page as generated by the server of FIG. 1; and

FIG. 9 shows a flowchart showing how the server of FIG. 1 processes the information.

### DETAILED DESCRIPTION OF THE DISCLOSURE

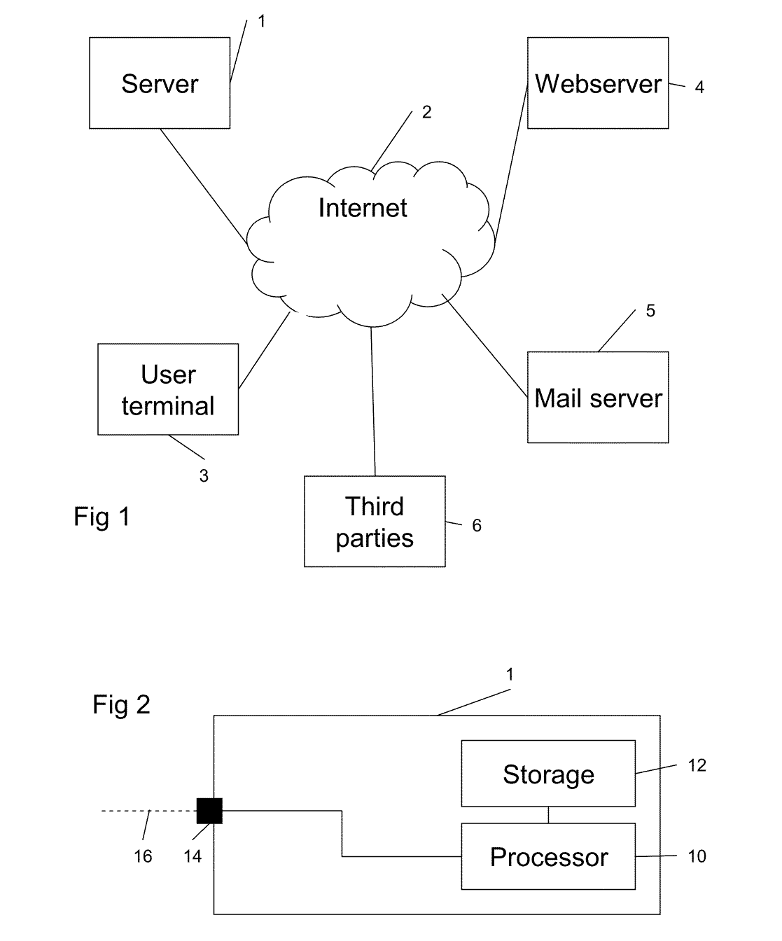

A network functioning in accordance with an embodiment of the disclosure is shown in FIG. 1 of the accompanying drawings. This comprises a server 1 connected via the Internet 2 to a user terminal 3 (typically of the form of a personal computer).

The hardware associated with the server 1 can be seen in more detail in FIG. 2 of the accompanying drawings. The server 1 comprises processing circuitry, such as a processor 10, which can be any suitable microprocessor, such as those available from Intel Corporation under the brand Intel Core i7. The server also comprises storage 12, typically including volatile random access memory for short term storage of data and program instructions, and one or more non-volatile mass storage devices, such as magnetic hard disks, flash memory or optical storage for longer term data and program storage. The processor 10 is in communication with the storage 12. The processor 10 is also in communication with a network interface 14 of the server 1, which acts as an input and output to the Internet 2 via network connection 16.

As such, the server can be implemented as a computing device such as a personal computer, workstation or dedicated (typically rackmounted) server, and may be, for example, a computer running on any Intel x86 architecture with a Microsoft Windows®, Apple Mac OS X® or Unix® based operating system.

In use, the user will interact with the server 1 by loading web pages hosted on the server 1 on his user terminal 3 across the Internet 2, using web browser software (such as the Mozilla Foundation's Firefox software).

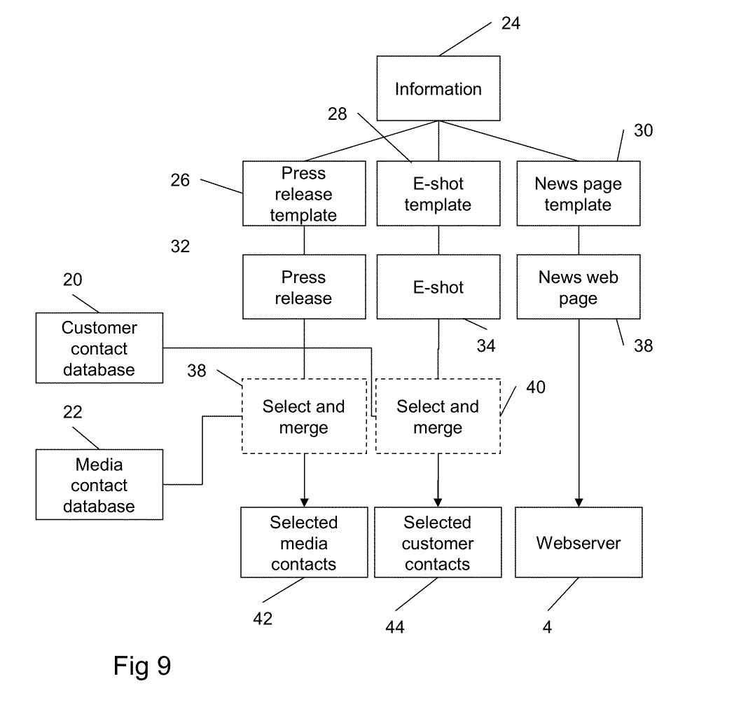

The storage 12 holds two databases 20, 22 (shown in FIG. 9 of the accompanying drawings). The customer contact database 20 contains a list of contacts uploaded to the server 1 by the user. For example, the entries in this database could be a user's customers. Each entry will contain various details for a particular contact, and will generally contain at least the contact's name and email address.

The media contact database 22 contains a list of contacts provided by the operator of the server 1. Each of these entries will be a media professional or other such contact, working in particular and identified field. Again, each entry will contain the details of one such contact, including their name, their email address and details of the publication for which they work.

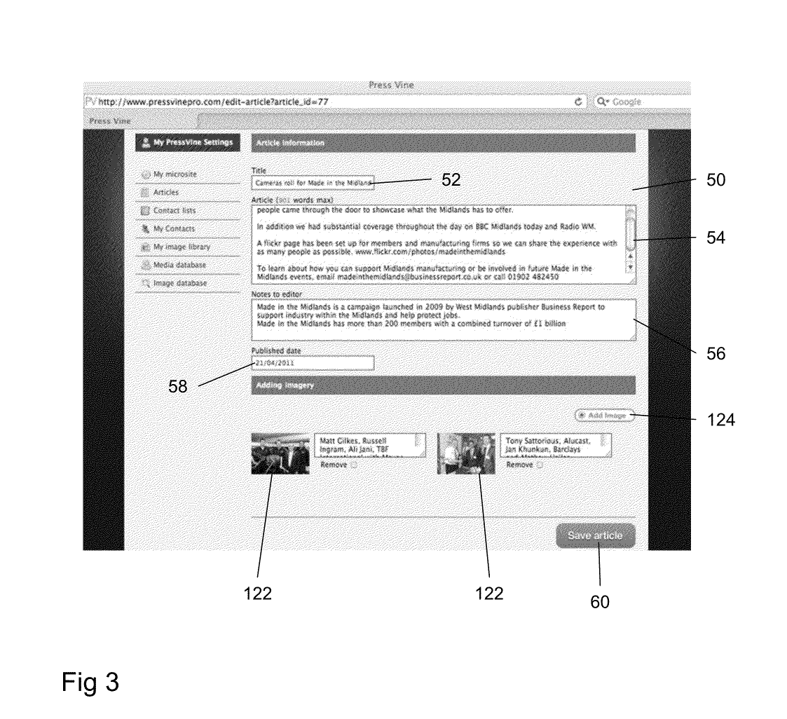

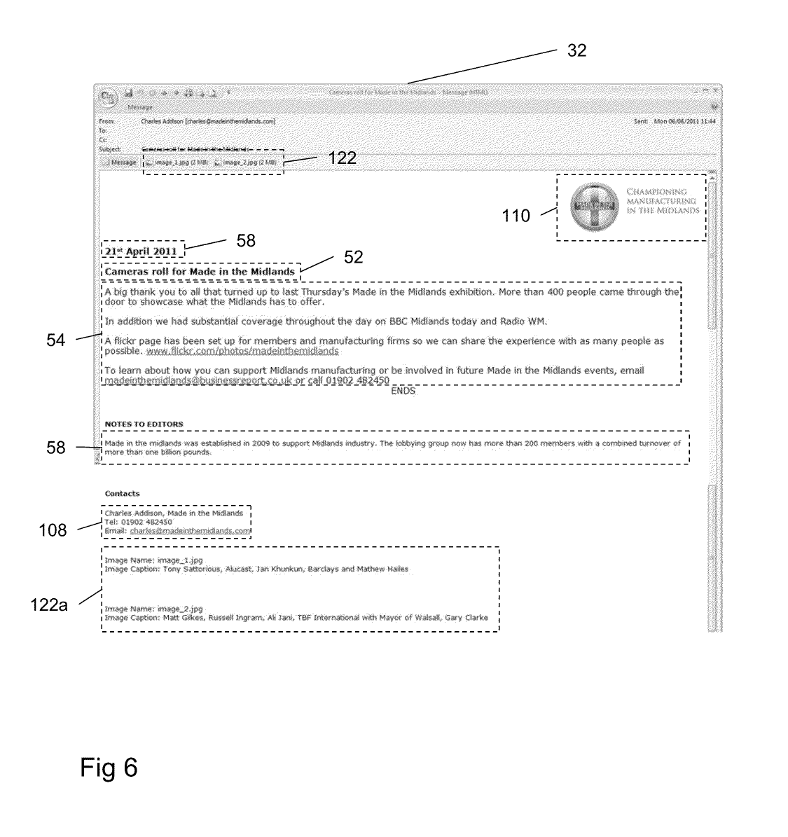

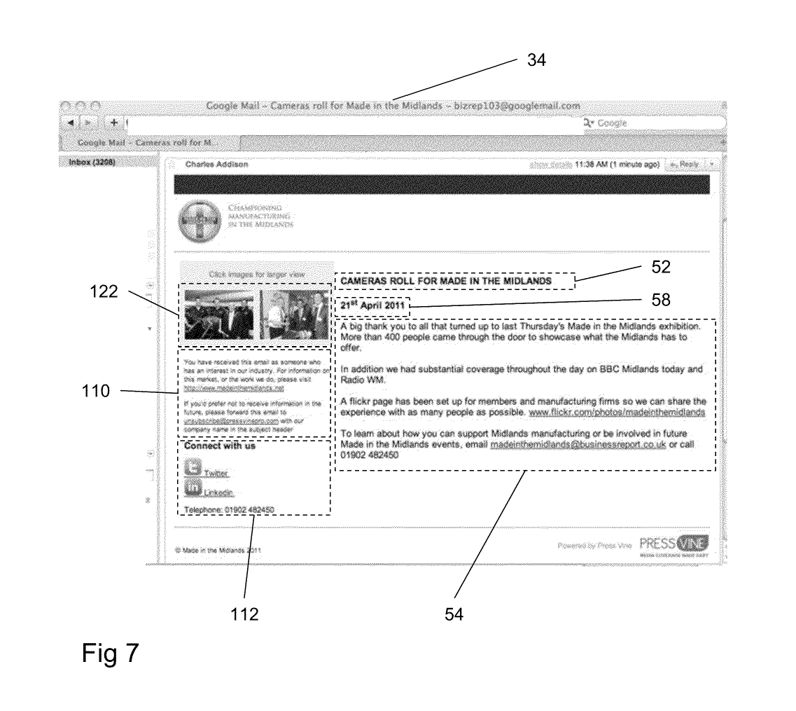

In order to disseminate information provided by the user, the processor 10 is provided with program instructions (stored in storage 12) which cause it to carry out a method as now described with reference to FIG. 9 of the accompanying drawings. FIGS. 3 to 8 of the accompanying drawings show various output of the server 1, rendered as web pages (FIGS. 3 to 5, 8a and 8b) or email messages (FIGS. 6 and 7); in these figures, boxes shown in dotted lines would not appear in output; they are simply to indentify areas of the documents in question.

The user enters their information 24 into a web page form 50, such as that shown in FIG. 3 of the accompanying drawings. The form 50 contains fields for a title 52 for the information, a body 54 of the information, background notes 56 and a publication date 58. Together, the contents of the fields 52, 54, 56, 58 constitute the information 24 to be disseminated.

Once the user is satisfied that they have correctly entered the information into the form 50, they select the submit button 60. This uploads the information 24 to the server 1.

The processor 10 applies different templates to the information 24 in order to create electronic messages to be sent to the selected contacts. The processor applies a press release template 26 to the information 24 to create a press release 32. It also separately applies a E-shot template 28 to the information 24 to create an E-shot 34 (akin to a mailshot, but applied to an electronic message). The difference in results can be seen in FIGS. 6 and 7 of the accompanying drawings.

In FIG. 6, the press release 32 is shown. The press release 32 is based upon the standard format of press release that a media contact such as a journalist would expect to receive. The format is fairly plain and unfussy, and the information follows in a predictable pattern: date 58, followed by title 52, followed by body 54. The body section is followed by a standard terminator “ENDS” to show that the end of the body 54 of the information has been received. This is followed by “notes to editors” which comprises the background information 58, followed by contact details 108 for the user, which are automatically added by the template 26. Also added is the user's logo 110, which will add a touch of professionalism and individuality to the press release. Both the logo 110 and the contact details 108 are added on a user-by-user basis by the template 26.

In FIG. 7, the E-shot 34 is shown. This is presented in a much more eye-catching way, as there is much more desire to produce something visually eye-catching for the user's own contacts than for media professionals (who might find such presentation off-putting). The title 52, date 58 and body 54 are presented in order, in a user-friendly layout. There is no need for the background information 58, as a user's contacts can generally be trusted to know of the user, whereas media professionals may not. Also included in the E-shot 34 by template 28 are some predefined text 110 (here relating to contact details for more information and how to unsubscribe from further E-shots) and links 112 to social networking sites relating to the user; these sections can be predefined by the user for all of their E-shots.

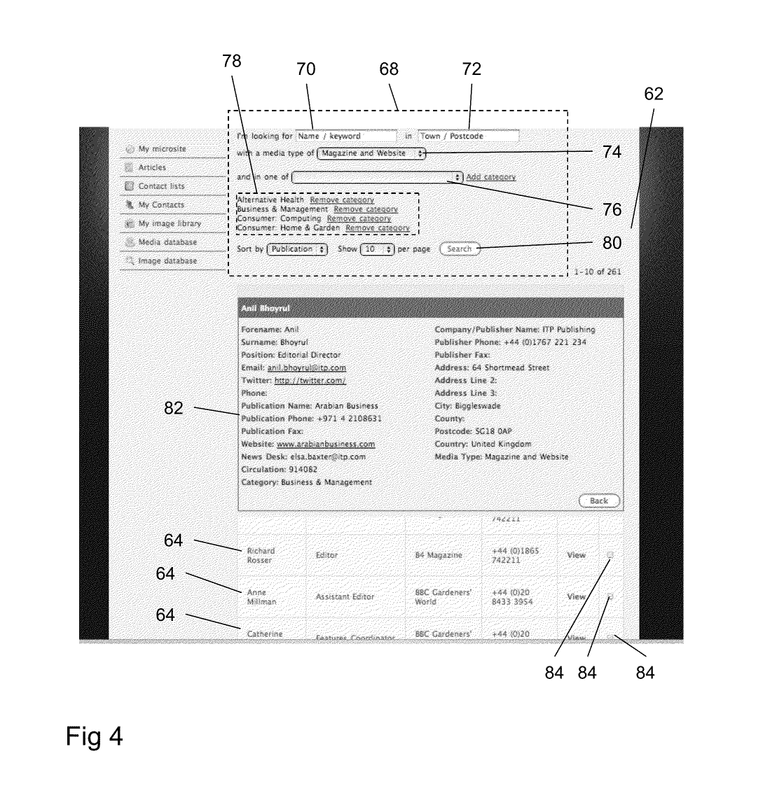

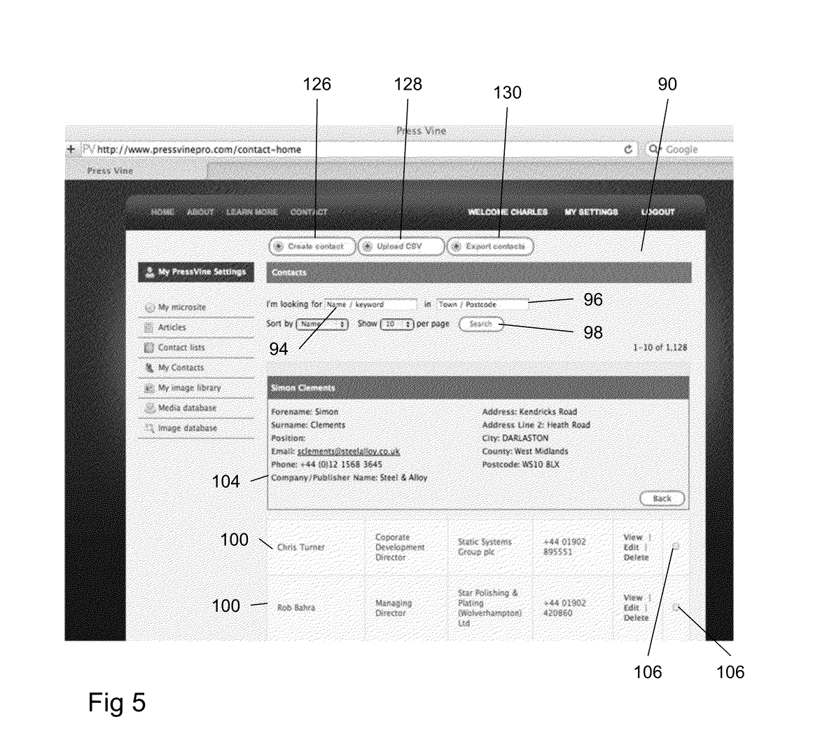

The user has the opportunity to select the contacts to which the information is to be disseminated. The user can select separately (as part of steps 38 and 40 shown in FIG. 9) the contacts to which he desires to send the information. This is demonstrated in more detail in FIGS. 4 and 5 of the accompanying drawings.

FIG. 4 shows the web page form 60 to allow the user to select the desired contacts from the media contact database 22. A search interface 68 allows a user to query the media contact database 22, by name 70, location 72, media type 74 and media subject matter category 76. Examples of the media subject matter categories presently selected are shown at 78.

Selecting the “search” button 80 sends a query to the media contact database, which returns the results in table 66. A plurality of entries 64 retrieved from the media contact database 22 is shown in the table 66. By selecting an entry 64, further details relating to that entry (including name, address, telephone numbers, email addresses and other miscellaneous information) are shown in dialog box 82.

The user can then select a subset of the search results by clicking on the check box 84 for each of the media contacts 64 to which he wants to send the information.

Similarly, in order to make a selection of the customer contacts, the user is presented with the web page form 90 shown in FIG. 5 of the accompanying drawings. This also has a search interface 92, which allows the user to search the customer contact database 20 by name 94 or location 96.

Selecting the “search” button 98 sends a query to the customer contact database 20, which returns the results in table 100. A plurality of entries 102 retrieved from the customer contact database is shown in the table 100. By selecting an entry, further details relating to that entry (including name, address, telephone number and email address) are shown in dialog box 104.

The user can then select a subset of the search results by clicking on the check box 106 for each of the customer contacts 102 to which he wants to send the information.

Thus, the user has selected two subsets of contacts 42, 44 from each of the supersets being all the contacts of the media contact database 22 and the customer contact database 20 respectively.

The processor creates (in steps 38 and 40) electronic messages (typically email messages according to well-defined standards such as RFC 5322) to each of the selected contacts. For the contacts of the subset 42 selected from the media contact database 22, the processor creates an electronic message containing the press release 32. For the contacts of the subset 44 selected from the customer contact database 20, the processor creates an electronic message containing the E-shot 34.

The electronic messages are then sent to the selected contacts; typically, the electronic messages will be sent using the network interface 14 to mail server 5 across the Internet 2 for onward transmission. Thus, the selected media contacts 42 will receive a professional-looking press release 32, whilst the selected user's contacts 44 will receive a user-friendly E-shot 34, all with the user only having to enter the information 24 once and without having to separately format the information 24 to send it to each subset 42, 44 of recipients.

In addition to sending the information as electronic messages, the processor can, on demand, send the information to a webserver 4 (which can be connected to the server 1 via the Internet 2 or can in fact be the same server) in order to update the user's news web page. The processor 10 applies a news page template 36 to the information 24 to generate a news web page 36 containing the information.

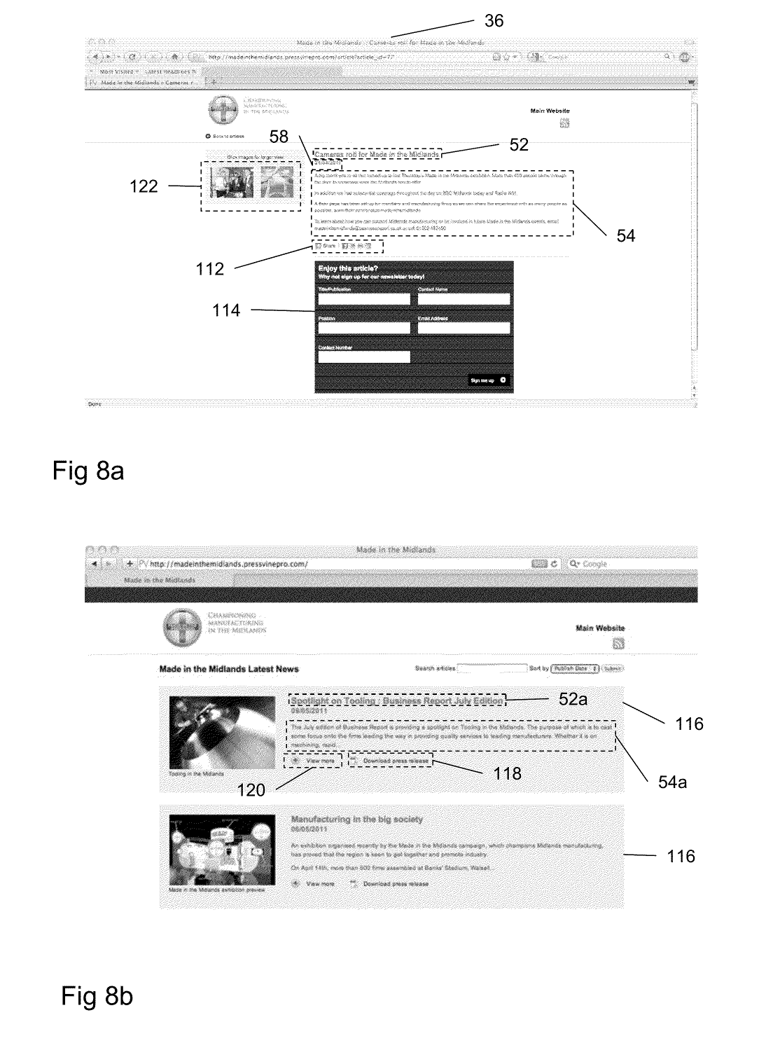

The new web page 36 created will contain appropriate hypertext markup language (HTML) to appear as shown in FIG. 8a of the accompanying drawings, with the title 52, date 58 and body 54 of the information attractively displayed. Links 112 to social networking sites are also provided. Furthermore, a web form 114 is provided whereby a third party 6 browsing the news web page 36 over the Internet 2 can request to be added to the user's customer contact database. This can be automated at the server 1, but may require the user's authorisation to prevent false or malicious entries being made.

The processor will also update an index page, an example of which is shown at FIG. 8b of the accompanying drawings; each set of information 24 sent out will form one story entry 116, each story entry comprising the title 52 and a truncated version of the body 54a of the relevant information 24. Each entry 116 will also contain a link 118 to the information as formatted as a press release 32 (saved on the webserver 4 as a portable document format (PDF) file) and a link 120 to the relevant news web page 36.

Where the webserver 4 is not the server 1, as shown in the Figures, the server 1 will achieve this by transferring appropriate HTML files to the webserver 4 by an appropriate file transfer protocol (such as the File Transfer Protocol (FTP) or Secure Copy (SCP)); where the server 1 and the webserver 4 are the same server, the server 1 merely needs to save the appropriate HTML files in the location on the storage 12 from which the web server 4 serves files.

Again, this updating of the user's news web page occurs with the user only having had to upload the information 24 once; the user does not have to separately create and upload a news web page update at the same time as creating the press release or E-shot.

In addition to creating the news web page, the server may also send at least the title 52 and a link to the news web page 36 to whichever social networks the user subscribes to; such networks include traditional social networking sites such as Facebook® and LinkedIn®, as well as microblogging sites such as Twitter®. This enables contacts of the user on those social networking sites to access the news page, again with the user only having to enter the information 24 once.

The system of this embodiment is also designed to deal with photos. Photos 122 can be uploaded by the user to the server 1, where they are stored on the storage 12. When uploading the information 24, the user can select which, if any, photos 122 are to be associated with the information 24, by making a selection of link 124 (FIG. 3) and selecting the photos 122 from those stored by the user on the storage 12. The photos will then be displayed in an appropriate format by each template 26, 28, 30: for the press release 32, the photos 122 will be attached as attachments with associated description 122a; for the E-shot 34 and the news web page 36 the photos 122 will be displayed as thumbnails (reduced sized versions of the photos) linked to full-sized versions on the webserver 4.

Thus, the media contacts are sent full sized versions of the photos 122 to use in their publications, as they would expect, whereas the user's contacts and casual web browsers automatically receive smaller versions with links to larger versions that they can view if desired. This automatically occurs without user intervention; all the user has to do is select the appropriate photo and then the photo is reformatted appropriately by the server 1 without further input from the user.

Uploading the user's contacts to the customer contact database 20 is simple for the user; links are provided on the screen shown in FIG. 5 and discussed above to assist with this task. A link 126 is provided to add a single contact via a web form. A further link 128 is provided whereby a user can upload a comma separated values (CSV) file containing multiple entries to uploaded simultaneously. Such CSV files are easily created from the user's own customer databases, and can be used to upload contacts in bulk; there is no reason why other formats of files (spreadsheets or databases) could be used to upload this data to the server 1. A final link 130 is provided to export the customer contact database 20 should the user so desire.

The protection sought is not to be limited to the embodiments disclosed, which are given by way of example only, but instead is to be limited only by the scope of the appended claims.

1. A method of disseminating information, comprising uploading information to a server, selecting a first set of recipients and a second set of recipients, applying at the server a first template to the information to create a first electronic message, applying at the server a second template to the information to create a second electronic message, and the server sending the first electronic message to the first set of recipients and the second electronic message to the second set of recipients.

2. The method of claim 1, in which the first set of recipients is selected from a first superset of potential recipients; the second set of recipients is selected from a second superset of potential recipients; and the first superset and the second superset of recipients are not equal.

3. The method of claim 2 in which the first superset and the second superset each comprise potential recipients, taken from different sources.

4. The method of claim 3, in which the first superset comprises potential recipients provided other than by a user uploading the information.

5. The method of claim 2, in which the second superset comprises potential recipients provided by the user uploading the information to the server.

6. The method of claim 1, further comprising the step of sending at least some of the information to a webserver, so that the information sent appears on a web page.

7. The method of claim 6, in which the web page is a news page for the user, the method comprising the server applying a news page template to the information sent to the web server.

8. The method of claim 7, in which the web server contains a news page for each of a plurality of users of the server; a different news page template being provided for each user of the server.

9. The method of claim 6, further comprising sending a subset of the information to a further webserver, so as to appear on a further web page.

10. The method of claim 9, in which the information sent to the further website comprises a link to the web page of the webserver, so that the further web page links to the web page.

11. A server for disseminating information, the server comprising:
an input configured to receive information;
storage configured to store a first superset of recipients and a second superset of recipients;
processing circuitry configured to access a user selection of a first set of recipients from the first superset of recipients, to access a user selection of a second set of recipients from the second superset of recipients, to apply a first template to the information to create a first electronic message, and to apply a second template to the information to create a second electronic message, and to control outputting of the first electronic message externally of the server to the first set of recipients and the second electronic message externally of the server to the second set of recipients.

12. The server of claim 11, in which the first superset and the second superset of recipients are not equal.

13. The server of claim 11, in which the output is configured to send at least some of the information to a webserver, so that the information sent appears on a web page.

14. The server of claim 11, in which the server is configured to act as a webserver, so that the information sent appears on a web page served by the server.

15. The server of claim 13 in which the server is configured to apply a news page template to the information sent to create the web page.

16. The server of claim 14, in which the server is configured to apply a news page template to the information sent to create the web page.
